(19) United States
(12) Patent Application Publication
(10) Pub. No.: US 2016/0228327 A1
(43) Pub. Date: Aug. 11, 2016

(54) Method for Massaging with Audio Playback

(71) Applicant: Ellen Makarewicz-Ely, Davison, MI (US)

(72) Inventor: Ellen Makarewicz-Ely, Davison, MI (US)

(21) Appl. No.: 15/041,993

(22) Filed: Feb. 11, 2016

Related U.S. Application Data
(60) Provisional application No. 62/114,721, filed on Feb. 11, 2015.

(51) Int. Cl. A61H 99/00; G06F 3/16

(52) U.S. Cl. CPC A61H 99/00; G06F 3/165

(57) ABSTRACT

A method used for relaxing the mind and the body of an individual receiving a massage, is provided with an audio file and a speaker. The speaker is communicably coupled with a data storage device containing the audio file. When the massage session is initiated, the audio file is played through the speaker. The audio file contains, a plurality of meditation exercises and a plurality of massage triggers. The plurality of meditation exercises helps the patient have relaxed mindset throughout the massage session. In order to do so, a set of physical breathing instructions and a set of visualization instructions are provided. On the other hand, the plurality of massage triggers is useful in guiding the massager throughout massage session.

The current application claims a priority to the U.S. Provisional Patent application Ser. No. 62/114,721 filed on Feb. 11, 2015.

### FIELD OF THE INVENTION

The present invention relates generally to a method used for massaging, More specifically, the present invention provide audio information that can be used to maximized the benefits of a massage session.

### BACKGROUND OF THE INVENTION

The main intention of a massage is to relax the muscles of the body. However, due to various reasons that can vary from stress to illnesses, the user may not have a relaxed mindset during a massage session. The stress in the mind eventually transfers to the body, resulting in tension in the muscles. Similarly, if the client is experiencing an injury, certain muscles or muscle groups can be under tension. The tension can have a negative impact during a massage session since the massage therapist needs to devote additional time and effort to relax the muscles of the client.

Traditionally, a massage session is conducted with background music. The music is usually slow in nature and is intended to help relax the mind and body of the client getting the massage. Depending on the musical preference of the user and the state of mind of the user, the music can be beneficial or not be beneficial to relax the muscles of the user. Therefore, the need for a method that can successfully relax both the mind and the body simultaneously is clearly evident.

The objective of the present invention is to address the aforementioned issues. In particular, the present invention introduces a method that helps the user relax their mind and the body during a massage session. In doing so, the present invention introduces a meditation method that helps the user release stress causing thoughts and have a relaxed mind during the massage session. By relaxing the mind, the muscles of the user are also relaxed. Therefore, the massage therapist can conduct a successful massage therapy session such that the overall benefits of the massage session are maximized. In contrast to traditional massage methods, the present invention allows the user to practice relaxing the mind and the body even after the massage session is complete. In order to do so, the audio and music used in the present invention is provided to the individual receiving the massage. Therefore, the user can practice controlling the mind which can be beneficial in future massage sessions and in life in general.

### BRIEF DESCRIPTION OF THE DRAWINGS

FIG. 1 is a system diagram of the present invention.

FIG. 2 is a timeline of the present invention.

FIG. 3 is a flowchart illustrating the basic overall process of the present invention.

FIG. 4 is a flowchart illustrating the process of using the breathing instructions and the visualization instructions.

FIG. 5 is a flowchart illustrating the process of using the muscle-relaxing instructions and the visualization instructions.

FIG. 6 is a flowchart illustrating the process of using the self-reflection instructions.

FIG. 7 is a flowchart illustrating the process associated with a corresponding trigger played at a beginning of one of the plurality of meditation exercises.

FIG. 8 is a flowchart illustrating the process associated with a corresponding trigger played after a beginning of one of the plurality of meditation exercises.

FIG. 9 is a flowchart illustrating the overall process of the present invention with a musical arrangement.

### DETAIL DESCRIPTIONS OF THE INVENTION

All illustrations of the drawings are for the purpose of describing selected versions of the present invention and are not intended to limit the scope of the present invention.

The present invention introduces a method to be used during a massage session. More specifically, the present invention focuses on a method that can be used to relax the mind and the body of a client getting a massage. Since a relaxed mind and body are proven to have a great effect on a successful massage, utilizing the present invention ensures that the client receives a good massage.

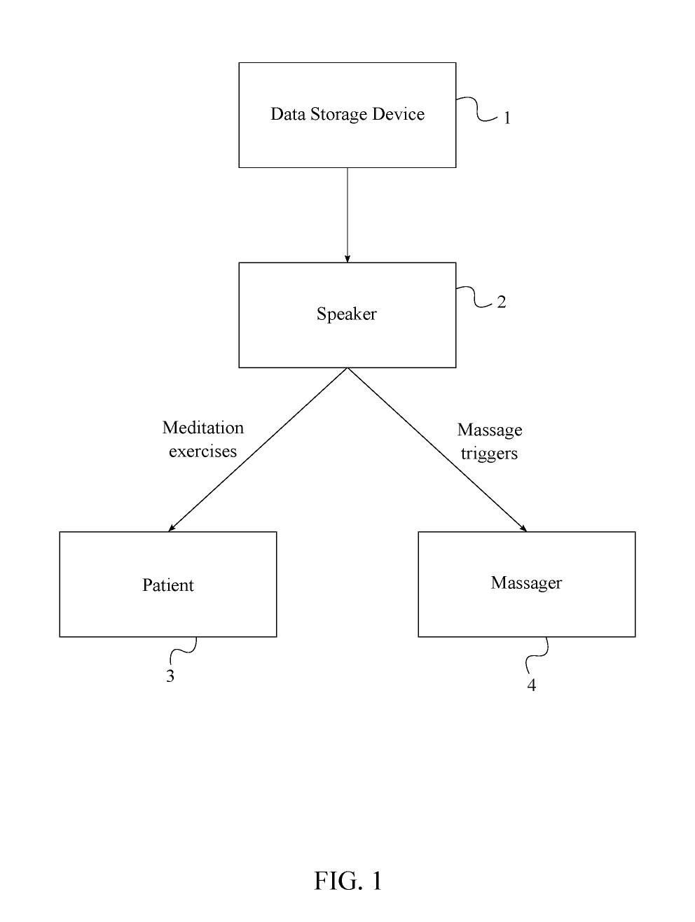

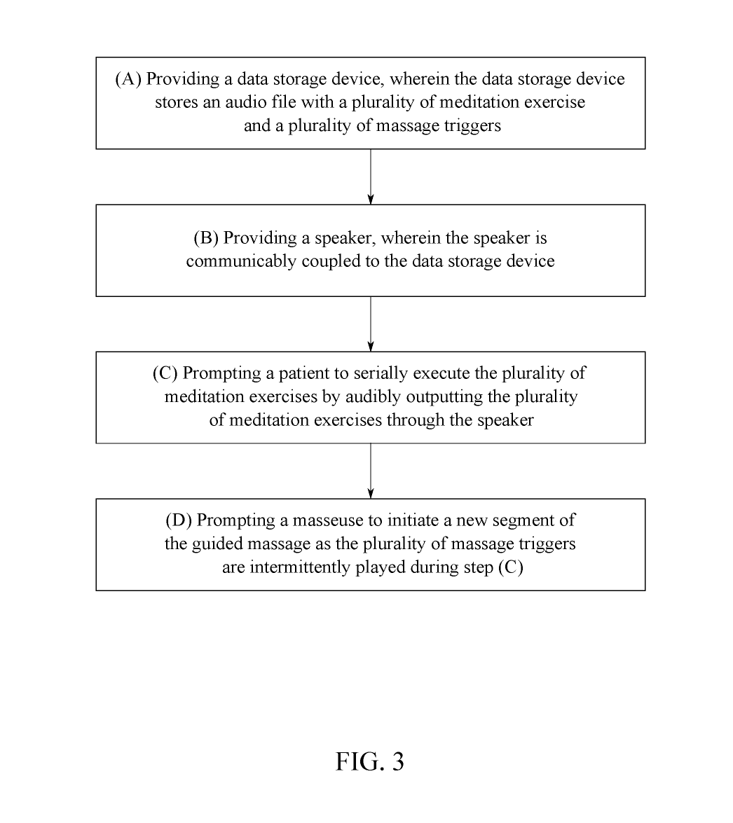

The present invention is intended to be played during a massage session. In order to do so, the present invention is provided with a data storage device 1 and a speaker 2 as seen in FIG. 1. The data storage device 1, which can vary in different embodiments of the present invention, stores an audio file with a plurality of meditation exercises and a plurality of massage triggers. In order to play the audio file during the massage session the speaker 2 is communicably coupled to the data storage device 1. When the massage session is initiated, the present invention prompts a patient 3, who is the individual receiving the massage, to serially execute the plurality of meditation exercises. In order to do so, the present invention audibly outputs the plurality of meditation exercises through the speaker 2. Moreover, the present invention prompts the massager 4 to initiate at least one new segment of the guided massage with the plurality of massage triggers. As illustrated in FIG. 3, the plurality of massage triggers for the massager 4 is played intermittently with the plurality of meditation exercises. Resultantly, the massager 4 executes the massage on a certain body part of the patient 3, while the patient 3 is participating in the plurality of meditation exercises. As an example, when the plurality of meditation exercises describe a specific body portion, the massager 4 executes the massage on the specific body portion.

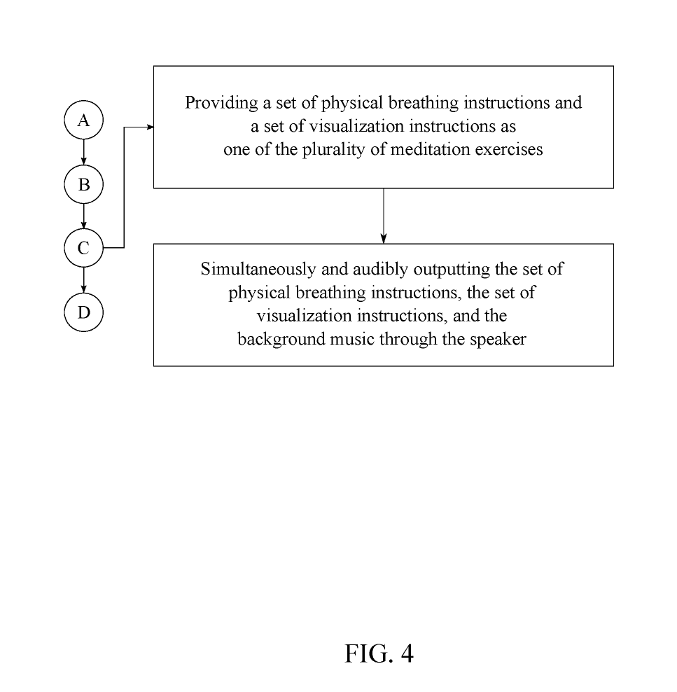

In the preferred embodiment of the present invention, the plurality of meditation exercises is mainly categorized into breathing related meditations and visualization related meditation. As shown in FIG. 4, in order to address the breathing related meditations, a set of physical breathing instructions is provided. Similarly, a set of visualization instructions is provided to address the visualization related meditation. Both the set of physical breathing instructions and the set of visualization instructions, which are provided as one of the plurality of meditation exercises, are intended to relax the mind of the individual receiving the massage. In order to do so, the present invention simultaneously and audibly outputs the set of physical breathing instructions and the set of visualization instructions through the speaker 2. The set of physical breathing instructions focus on inhaling, exhaling, and movements of the breath. On the other hand, the set of visualization instructions help the user visualize the movement of the breath throughout the body. Moreover, the set of visualization instructions is also designed to alleviate mental stress or physical pain.

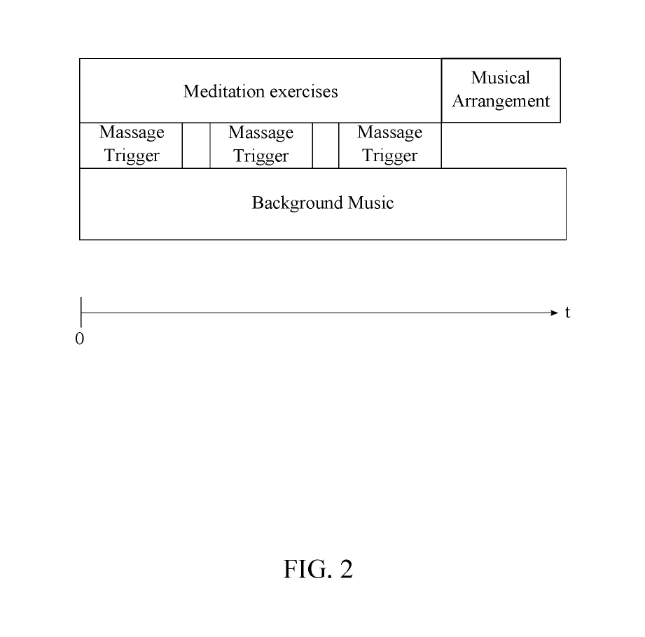

As seen in FIG. 2, in addition to the set of physical breathing instructions and the set of visualization instructions, the present invention can also include background music for additional relaxation purposes. In such instances, the background music is simultaneously and audibly outputted through the speaker 2 with the set of physical breathing instructions and the set of visualization instructions. In addition to contributing to relaxing the mind of patient 3 receiving the massage, the background music also helps block external noises which can distract the patient 3 during the massage session.

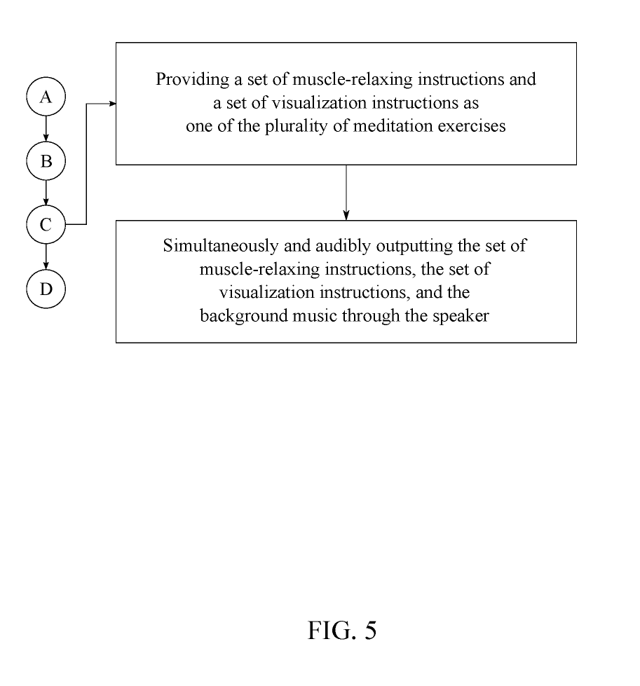

The present invention can also be used to address physical pain experienced by the individual receiving the massage. The physical pain can be, but is not limited to, chronic pain, pain from an injury, or pain due to an illness. As seen in FIG. 5, in order to address the physical pain, the present invention provides a set of muscle-relaxing instructions and a set of visualization instructions as one of the plurality of meditation exercises. The set of muscle-relaxing instructions helps the individual receiving the massage focus on specific muscle groups that are causing physical pain. On the other hand, the set of visualization instructions help the individual mentally visualize the pain being taken away from the body. More specifically, the set of visualization instructions is designed to alleviate mental stress or physical pain. In order to do so, the set of muscle-relaxing instructions and the set of visualization instructions are audibly outputted through the speaker 2 simultaneously. As mentioned previously, background music can be audibly outputted through the speaker 2 simultaneously with the set of muscle- relaxing instructions and the set of visualization instructions.

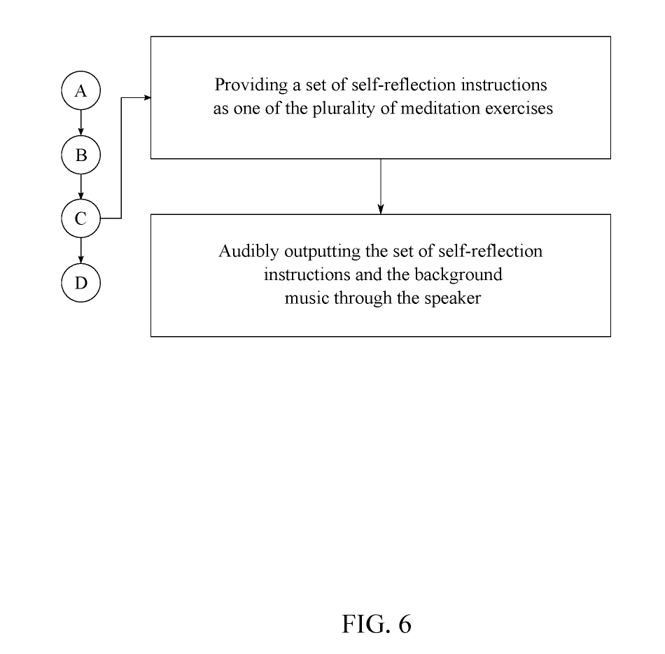

As illustrated in FIG. 6, a set of self-reflection instructions is provided as one of the plurality of meditation exercises. The main intention of the self-reflection instructions is to enhance positive thinking in the mind of the individual receiving the massage. In order to do so, the present invention audibly outputs the set of self-reflection instructions through the speaker 2. The set of self-reflection instructions encourage the patient 3 to improve positive thinking which ultimately lead to a positive lifestyle. In addition to the set of self-reflection instructions, the present invention can also output background music through the speaker 2 with the self-reflection instructions. As discussed earlier, the background music can be beneficial in relaxing the mind of the client, and also in blocking out external noises that can hinder the massage process.

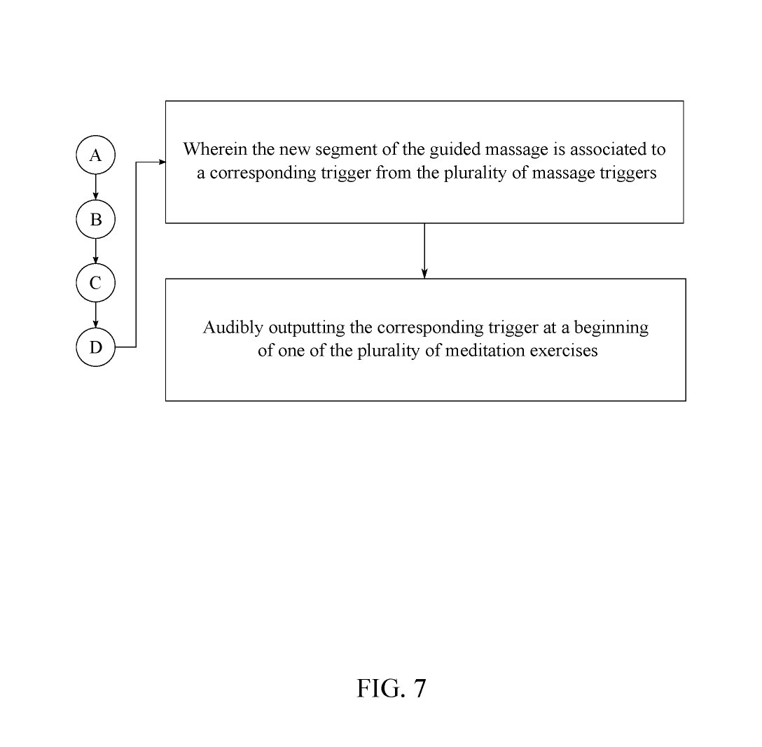

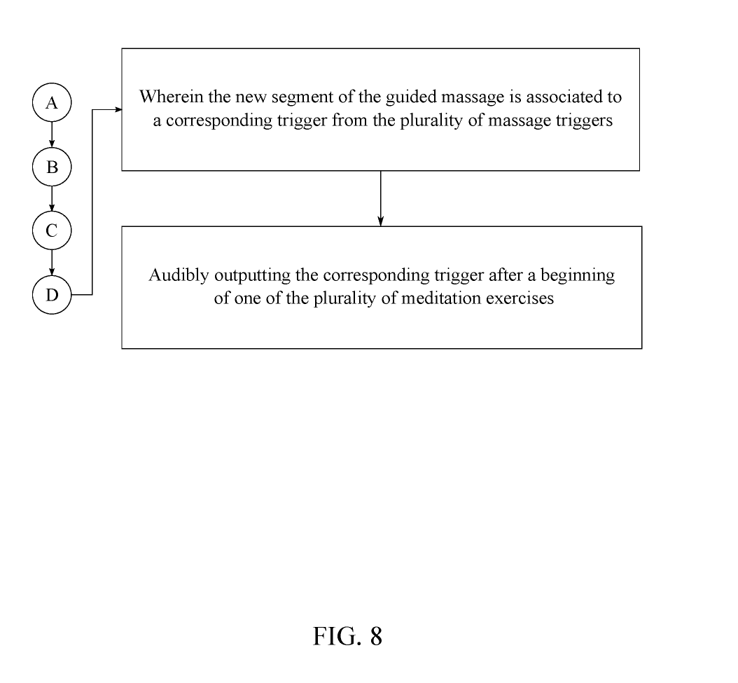

As previously discussed, the massager 4 is prompted to initiate the new segment as instructed in the plurality of massage triggers. In order to do so, the new segment is associated to a corresponding trigger from the plurality of massage triggers. As an example, if the corresponding trigger refers to the ankles of the patient 3, the massager 4 focuses on treating the ankles. As shown in FIG. 7, the corresponding trigger is audibly outputted at a beginning of one of the plurality of meditation exercises. As the massage session progresses, the present invention audibly outputs a corresponding trigger after a beginning of one of the plurality of meditation exercises as illustrated in FIG. 8. The massager 4 is then prompted to execute the massage session according to the corresponding trigger played after the beginning of one of the plurality of meditation exercises. As an example, if the massager 4 was performing the massage to the ankles, the massager 4 then progresses to the calf muscles or other body part referred by the corresponding trigger.

The present invention is designed to cater a wide variety of patients. Certain individuals may prefer a full body massage, while other patients prefer a partial body massage. In order to cater the varied preferences, the audio file is designed lengthwise for a full body massage. In another embodiment of the present invention, the audio file is designed lengthwise for a partial body massage.

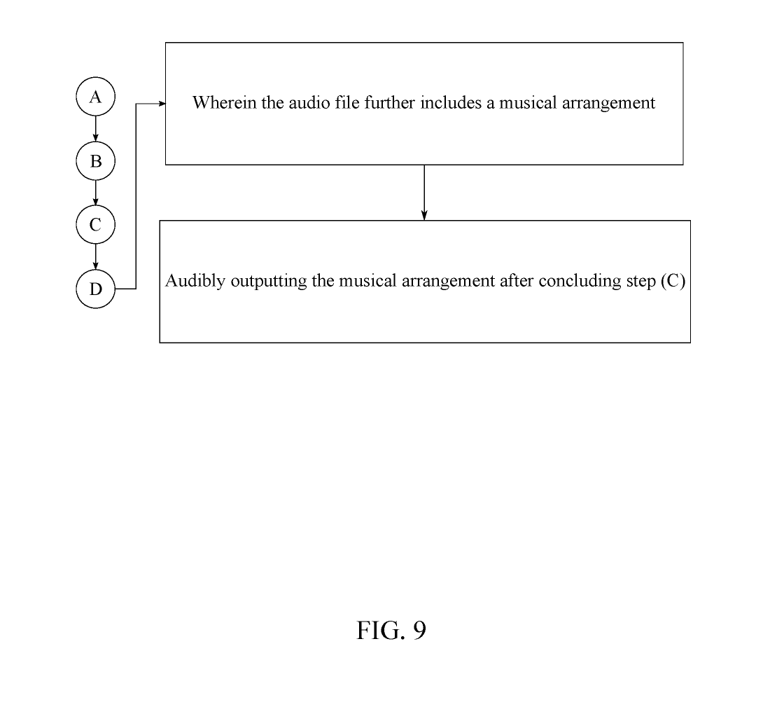

In order to maintain the relaxed state of the patient 3, the audio file further includes a musical arrangement as shown in FIG. 9. The length of the musical arrangement can vary in different embodiments of the present invention. When the patient 3 concludes the plurality of meditation exercises, the speaker 2 audibly outputs the musical arrangement for a predetermined time period allowing the patient 3 to maintain the relaxed state of mind.

When the present invention is being utilized the following process flow can be followed. The audio file is played through the speaker 2 as the massage session is initiated. The patient 3 follows the plurality of meditation exercises played by the speaker 2 throughout the massage sessions. More specifically, the patient 3 continues to focus on relaxing the mind by following the meditation exercise introduced in the present invention. In order to do so, the patient 3 follows the set of physical breathing instructions and the set of visualization instructions. Simultaneously, the massager 4 continues the massage session while responding to the plurality of massage triggers. Based on the preference of the patient 3 or the setting in which the audio file is played, background music can be played along with the audio file. At the conclusion of the massage session, the patient 3 is provided with the audio file. Therefore, the patient 3 can practice relaxing the mind and body even when a massage is not being performed.

Although the invention has been explained in relation to its preferred embodiment, it is to be understood that many other possible modifications and variations can be made without departing from the spirit and scope of the invention as hereinafter claimed.

What is claimed is:

1. A method used to conduct a body massage comprises the steps of:
(A) providing a data storage device, wherein the data storage device stores an audio file with a plurality of meditation exercises and a plurality of massage triggers;
(B) providing a speaker, wherein the speaker is communicably coupled to the data storage device;
(C) prompting a patient to serially execute the plurality of meditation exercises by audibly outputting the plurality of meditation exercises through the speaker; and
(D) prompting a massager to initiate at least one new segment of the guided massage as the plurality of massage triggers is intermittently played during step (C).

2. The method used to conduct a body massage as claimed in claim 1 comprises the steps of:
providing a set of physical breathing instructions and a set of visualization instructions as one of the plurality of meditation exercises; and
simultaneously and audibly outputting the set of physical breathing instructions and the set of visualization instructions through the speaker.

3. The method used to conduct a body massage as claimed in claim 2 comprises the steps of:
simultaneously and audibly outputting background music through the speaker with the set of physical breathing instructions and the set of visualization instructions.

4. The method used to conduct a body massage as claimed in claim 2, wherein the set of visualization instructions is designed to alleviate mental stress or physical pain.

5. The method used to conduct a body massage as claimed in claim 1 comprises the steps of:
providing a set of muscle-relaxing instructions and a set of visualization instructions as one of the plurality of meditation exercises; and
simultaneously and audibly outputting the set of muscle-relaxing instructions and the set of visualization instructions through the speaker.

6. The method used to conduct a body massage as claimed in claim 5 comprises the steps of:
simultaneously and audibly outputting background music through the speaker with the set of muscle-relaxing instructions and the set of visualization instructions.

7. The method used to conduct a body massage as claimed in claim 5, wherein the set of visualization instructions is designed to alleviate mental stress or physical pain.

8. The method used to conduct a body massage as claimed in claim 1 comprises the steps of:
providing a set of self-reflection instructions as one of the plurality of meditation exercises; and
audibly outputting the set of self-reflection instructions through the speaker.

9. The method used to conduct a body massage as claimed in claim 8 comprises the steps of:
audibly outputting background music through the speaker with the set of self-reflection instructions.

10. The method used to conduct a body massage as claimed in claim 1 further comprises the steps of:
wherein the new segment of the guided massage is associated to a corresponding trigger from the plurality of massage triggers; and
audibly outputting the corresponding trigger at a beginning of one of the plurality of meditation exercises.

11. The method used to conduct a body massage as claimed in claim 1 further comprises the steps of:
wherein the new segment of the guided massage is associated to a corresponding trigger from the plurality of massage triggers;
audibly outputting the corresponding trigger after a beginning of one of the plurality of meditation exercises.

12. The method used to conduct a body massage as claimed in claim 1, wherein the audio file is designed lengthwise for a full body massage.

13. The method used to conduct a body massage as claimed in claim 1, wherein the audio file is designed lengthwise for a partial body massage.

14. The method used to conduct a body massage as claimed in claim 1 further comprises the steps of:
wherein the audio file further includes a musical arrangement;
audibly outputting the musical arrangement after concluding step (C).
